(19) United States
(12) Patent Application Publication
(10) Pub. No.: US 2026/0249850 A1
(43) Pub. Date: Aug. 27, 2026

(54) CONTROL DEVICE FOR VEHICLE

(71) Applicant: TOYOTA JIDOSHA KABUSHIKI KAISHA, Toyota-shi (JP)

(72) Inventor: Masato YOSHIKAWA, Toyota-shi (JP)

(21) Appl. No.: 19/418,758

(22) Filed: Dec. 12, 2025

(30) Foreign Application Priority Data
Feb. 21, 2025 (JP) 2025-027349

(51) Int. Cl. B60W 30/18; B60K 6/40; B60W 10/02; B60W 10/06; B60W 10/26; B60W 20/13; B60W 20/40

(52) U.S. Cl. CPC B60W 30/18127; B60K 6/40; B60W 10/02; B60W 10/06; B60W 10/26; B60W 20/13; B60W 20/40; B60W 2510/0638; B60W 2710/021; B60W 2710/025; B60W 2710/0627; B60W 2710/0644; B60W 2710/18; B60W 2710/244; B60W 2720/106; B60Y 2200/92

(57) ABSTRACT

When the target deceleration force cannot be achieved with the engine braking force and the regenerative braking force by the electric motor within the range of the inputtable electric power, the fuel cut is performed and the direct coupling clutch is disengaged. Power running of the first electric motor is performed to maintain a predetermined engine rotational speed higher than the rotational speed of the engine with the direct coupling clutch engaged. Regeneration of the second electric motor is performed to generate electric power corresponding to electric power obtained by adding the generated electric power corresponding to the inputtable electric power and the electric power consumed by the power running of the first electric motor. Consequently, a deceleration force larger than the deceleration force obtained with the engine braking force and the regenerative braking force by the electric motor within the range of the inputtable electric power can be obtained.

### CROSS-REFERENCE TO RELATED APPLICATION

This application claims priority to Japanese Patent Application No. 2025-027349 filed on February 21, 2025. The disclosure of the above-identified application, including the specification, drawings, and claims, is incorporated by reference herein in its entirety.

### BACKGROUND

### 1. Technical Field

The present disclosure relates to a control device for a vehicle including a power source including an engine and an electric motor, and a fluid transmission device including a direct coupling clutch.

### 2. Description of Related Art

Control devices for vehicles including a power source, a fluid transmission device, and a direct coupling clutch are well known. The power source includes an engine and an electric motor. The fluid transmission device is provided in a power transmission path between the power source and drive wheels. The direct coupling clutch couples an input member and an output member of the fluid transmission device. For example, Japanese Unexamined Patent Application Publication No. 2004-190493 (JP 2004-190493 A) describes such a control device for a vehicle. JP 2004-190493 A indicates that an appropriate engine braking force is secured by performing a fuel cut in which fuel supply to the engine is stopped while controlling the fluid transmission device to a slip state during deceleration travel with an accelerator turned off.

### SUMMARY

In the vehicle, it is also possible to generate a deceleration force by causing the electric motor to generate negative torque while controlling the fluid transmission device to an engaged state during deceleration travel. In this case, electric power generated by the electric motor is supplied to a power storage device that exchanges electric power with the electric motor. In this event, when the electric power that can be input to the power storage device is smaller than the electric power generated by the electric motor, negative torque for achieving a desired deceleration force cannot be generated by the electric motor. In this case, it is necessary to secure the engine braking force by cutting fuel for the engine. However, depending on the magnitude of the desired deceleration force, the desired deceleration force may not be achieved even when the engine braking force is added to the regenerative braking force caused by the regenerative operation of the electric motor.

The present disclosure has been made in view of the above circumstances. An object of the present disclosure is to provide a control device for a vehicle, the control device being capable of achieving a desired deceleration force even when a deceleration force obtained with an engine braking force and a regenerative braking force by an electric motor within the range of inputtable electric power is smaller than a target deceleration force.

A first aspect of the present disclosure provides
(a) a control device for a vehicle including a power source, a fluid transmission device, a direct coupling clutch, a second electric motor, and a power storage device. The power source includes an engine and a first electric motor. The fluid transmission device is provided in a power transmission path between the power source and a drive wheel. The direct coupling clutch couples an input member and an output member of the fluid transmission device. The second electric motor is coupled to the drive wheel not via the fluid transmission device so as to be able to transmit power. The power storage device exchanges electric power with an electric motor including the first electric motor and the second electric motor.
(b) The control device includes a deceleration control unit. The deceleration control unit determines that an engine braking force due to a fuel cut in which fuel supply to the engine is stopped is required and brings the direct coupling clutch into an engaged state, including a slip state and a completely engaged state, when a target deceleration force is not achieved within a range of electric power inputtable to the power storage device with a regenerative braking force due to regenerative operation of the electric motor in which electric power generated by the electric motor is input to the power storage device.
(c) When the target deceleration force is not achieved with the engine braking force due to the fuel cut and the regenerative braking force due to the regenerative operation of the electric motor in which the electric power is generated within the range of the inputtable electric power and with the direct coupling clutch in the engaged state, the deceleration control unit performs the fuel cut, brings the direct coupling clutch into a disengaged state, performs power running operation of the first electric motor in which a rotational speed of the engine is maintained at a predetermined engine rotational speed that is higher than the rotational speed of the engine with the direct coupling clutch in the engaged state, and performs regenerative operation of the second electric motor in which the second electric motor is caused to generate electric power corresponding to electric power obtained by adding the generated electric power corresponding to the inputtable electric power and electric power consumed by the power running operation of the first electric motor.

According to the first aspect of the present disclosure, it is determined that an engine braking force due to a fuel cut is required when a target deceleration force is not achieved within the range of electric power inputtable to the power storage device with a regenerative braking force due to regenerative operation of the electric motor. As a result of the determination, the direct coupling clutch is brought into the engaged state. Consequently, a deceleration force is obtained with the regenerative braking force due to the regenerative operation of the electric motor and the engine braking force, and thus the target deceleration force is easily achieved. When the target deceleration force is not achieved with the engine braking force and the regenerative braking force by the electric motor within the range of the inputtable electric power, the fuel cut is performed and the direct coupling clutch is brought into the disengaged state. In addition, power running operation of the first electric motor in which the rotational speed of the engine is maintained at a predetermined engine rotational speed that is higher than the rotational speed of the engine with the direct coupling clutch in the engaged state is performed. Further, regenerative operation of the second electric motor in which the second electric motor is caused to generate electric power corresponding to electric power obtained by adding the generated electric power corresponding to the inputtable electric power and electric power consumed by the power running operation of the first electric motor is performed. Consequently, the electric power consumed in the power running operation of the first electric motor is increased as compared with when the rotational speed of the engine is maintained at the rotational speed of the engine with the direct coupling clutch in the engaged state. Therefore, the electric power generated by the regenerative operation of the second electric motor is increased, and the regenerative braking force is also increased. The regenerative operation of the second electric motor that makes it possible to obtain a deceleration force larger than the deceleration force obtained with the engine braking force and the regenerative braking force by the electric motor within the range of the inputtable electric power is performed. Accordingly, it is possible to achieve a desired deceleration force even when a deceleration force obtained with an engine braking force and a regenerative braking force by an electric motor within the range of inputtable electric power is smaller than a target deceleration force.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining a schematic configuration of a vehicle to which the present disclosure is applied, and is a diagram for explaining a control function for various kinds of control in a vehicle and a main part of a control system;

FIG. 2 is a flowchart for explaining a main part of a control operation of the electronic control device, and is a flowchart for explaining a control operation for realizing a desired deceleration force;

FIG. 3 is a diagram illustrating an example of a time chart when the control operation illustrated in the flowchart of FIG. 2 is executed;

FIG. 4 is a flowchart for explaining a main part of a control operation of the electronic control device, and is a flowchart for explaining a control operation for realizing a desired deceleration force even when the deceleration force obtained by the engine braking force, the regenerative braking force by the electric motor within the range of the inputtable power, and the deceleration force obtained by the electric motor is smaller than the target deceleration force;

FIG. 5 is a diagram showing an exemplary time chart when the control operation shown in the flowchart of FIG. 4 is executed; and

FIG. 6 is a diagram for explaining a comparative example when the lock-up of LU clutch is disabled.

### DETAILED DESCRIPTION OF EMBODIMENTS

Hereinafter, embodiments of the present disclosure will be described in detail with reference to the drawings.

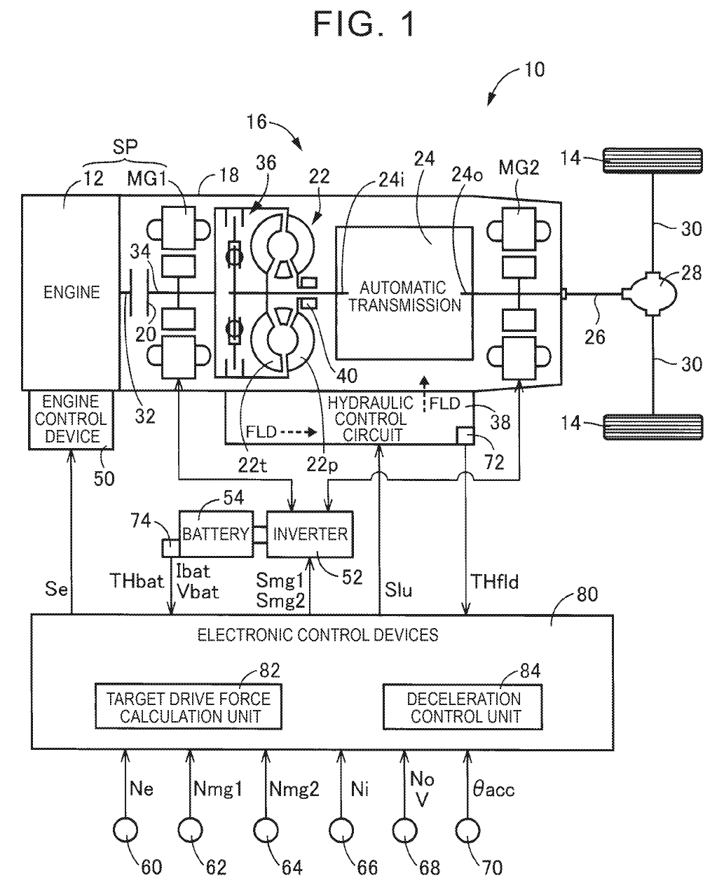

FIG. 1 is a diagram for explaining a schematic configuration of a vehicle 10 to which the present disclosure is applied, and is a diagram for explaining main parts of a control function and a control system for various kinds of control in the vehicle 10. In FIG. 1, a vehicle 10 is a hybrid electric vehicle including an engine 12, a first electric motor MG1, and a second electric motor MG2. The engine 12 and the first electric motor MG1 are power source SP of the present disclosure. The second electric motor MG2 is a power source different from the power source SP. The first electric motor MG1 and the second electric motor MG2 are the electric motor MG of the present disclosure. Further, the vehicle 10 includes a drive wheel 14 and a power transmission device 16 provided in a power transmission path between the engine 12 and the drive wheel 14.

The engine 12 is a known internal combustion engine that generates power by combustion of fuel. In the engine 12, the engine torque Te is controlled by the engine control device 50 provided in the vehicle 10 being controlled by an electronic control device 80 described later. The engine control device 50 includes, for example, a fuel injection device (not shown). The engine torque Te is the torque of the engine 12.

The electric motor MG are rotating electric machines each having a function as an engine for generating mechanical power from electric power and a function as a generator for generating electric power from mechanical power, and are so-called motor generators. The electric motors MG are each connected to a battery 54 provided in the vehicle 10 via inverters 52 provided in the vehicle 10. The battery 54 is a power storage device of the present disclosure that transmits and receives electric power to and from each of the electric motor MG. In each of the electric motors MG, the inverter 52 is controlled by an electronic control device 80, which will be described later, so that the electric motor torque Tmg which is the torque of the electric motor MG is controlled. The electric motor torque Tmg is the torque of the electric motor MG. The electric motor torque Tmg includes a first electric motor torque Tmg1 which is a torque of the first electric motor MG1, and a second electric motor torque Tmg2 which is a torque of the second electric motor MG2. The electric motor torque Tmg is, for example, a power running torque in a positive torque that is an acceleration side and a regenerative torque in a negative torque that is a deceleration side when the rotational direction of the electric motor MG is a positive rotational direction that is the same as the rotational direction of the engine 12. The electric power is also synonymous with electric energy unless otherwise distinguished. The power is synonymous with the drive force, the torque, and the force unless otherwise specified.

The power transmission device 16 includes a K0 clutch 20, a torque converter 22, an automatic transmission 24, and the like in a case 18 that is a non-rotating member attached to a vehicle body. K0 clutch 20 is a clutch provided between the engine 12 and the first electric motor MG1 in a power transmission path between the engine 12 and the drive wheels 14. The torque converter 22 is coupled to the engine 12 via a K0 clutch 20. The torque converter 22 is a fluid transmission device provided in a power transmission path between the power source SP and the drive wheels 14. The automatic transmission 24 is connected to the torque converter 22, and is a transmission provided in a power transmission path between the torque converter 22 and the drive wheels 14. The automatic transmission 24 is, for example, a known planetary gear type automatic transmission.

The power transmission device 16 includes a propeller shaft 26, a differential gear 28, a pair of drive shafts 30, and the like. The propeller shaft 26 is connected to the transmission output shaft 24o. The differential gear 28 is coupled to the propeller shaft 26. A pair of drive shafts 30 is coupled to the differential gear 28. The transmission output shaft 24o is an output rotating member of the automatic transmission 24. The power transmission device 16 includes, in the case 18, an engine coupling shaft 32 that couples the engine 12 and K0 clutch 20, an electric motor coupling shaft 34 that couples K0 clutch 20 and the torque converter 22, and the like. The power transmission device 16 is provided in a power transmission path between the power source SP and the drive wheels 14, except for K0 clutches 20.

The first electric motor MG1 is coupled to the electric motor coupling shaft 34 in the case 18 so as to be capable of transmitting power. That is, the first electric motor MG1 is connected to a power transmission path between the engine 12 and the drive wheels 14, in particular, a power transmission path between the engine 12 and the torque converter 22 so as to be able to transmit power. The engine 12 and the first electric motor MG1 are connected to each other via a K0 clutch 20 so as to be capable of transmitting power.

The second electric motor MG2 is connected in the case 18 to be able to transmit power to the transmission output shaft 24o. That is, the second electric motor MG2 is connected to the drive wheels 14 so as to be able to transmit power without passing through the torque converter 22 or the automatic transmission 24.

The torque converter 22 includes a pump impeller 22p coupled to the electric motor coupling shaft 34 and a turbine impeller 22t coupled to the transmission input shaft 24i. The transmission input shaft 24i is an input rotating member of the automatic transmission 24. The pump impeller 22p is an inputting member of the torque converter 22. The turbine impeller 22t is an outputting member of the torque converter 22. The torque converter 22 transmits the power from the power source SP from the electric motor coupling shaft 34 to the transmission input shaft 24i.

The torque converter 22 includes a lock-up clutch 36 (hereinafter, referred to as a LU clutch 36). LU clutch 36 is a direct coupling clutch that couples the pump impeller 22p and the turbine impeller 22t. LU clutch 36 is, for example, a known hydraulic frictional engagement device. The control status of LU clutch 36 is switched by changing LU torque Tlu by LU hydraulic pressure PRlu. LU hydraulic pressure PRlu is a regulated hydraulic pressure supplied to LU clutch 36 from the hydraulic control circuit 38 provided in the vehicle 10. LU torque Tlu is the torque capacity of LU clutch 36.

The control states of LU clutches 36 include a released state, a slipped state, and a fully engaged state. The slip state is a slip engaged state in which LU clutch 36 is engaged with a slip. In the present embodiment, the slip state and the fully engaged state are referred to as the engaged state, unless otherwise distinguished. That is, the engaged state of LU clutch 36 includes a slipped state and a fully engaged state. In the present embodiment, the engagement of LU clutch 36 is referred to as the lock-up of LU clutch 36. When LU clutch 36 is released, the torque converter 22 is brought into a torque converter state in which a torque amplifying action is obtained.

K0 clutch 20 is, for example, a hydraulic frictional engagement device constituted by a multi-plate type or single-plate type clutch. In K0 clutch 20, K0 hydraulic pressure PRk0 changes Tk0 of K0 torque to switch the control states such as the engaged state, the slipped state, and the released state. K0 hydraulic pressure PRk0 is the regulated hydraulic pressure supplied from the hydraulic control circuit 38 to K0 clutch 20. K0 torque Tk0 is the torque capacity of K0 clutch 20.

The vehicle 10 includes a mechanical oil pump 40. The oil pump 40 is connected to the pump impeller 22p, and is rotationally driven by a power source SP to discharge oil FLD used in the power transmission device 16. The oil FLD discharged from the oil pump 40 is supplied to the hydraulic control circuit 38. The hydraulic control circuit 38 supplies LU hydraulic pressure PRlu, K0 hydraulic pressure PRk0 and the like, which are adjusted in pressure based on the oil FLD discharged from the oil pump 40.

The vehicle 10 further includes an electronic control device 80 as a controller. The electronic control device 80 includes, for example, a so-called microcomputer including a CPU, RAM, ROM, an input/output interface, and the like. CPU performs various kinds of control of the vehicles 10 by performing signal-processing in accordance with a program stored in ROM in advance using, for example, a temporary storage function of RAM. The electronic control device 80 is a control unit of the present disclosure.

Various signals and the like based on detection signals by various sensors and the like provided in the vehicle 10 are input to the electronic control device 80. Examples of the various sensors include an engine rotational speed sensor 60, a first electric motor rotational speed sensor 62, a second electric motor rotational speed sensor 64, an input rotational speed sensor 66, an output rotational speed sensor 68, an accelerator operation amount sensor 70, an oil temperature sensor 72, and a battery sensor 74. Examples of the various types of signals include an engine rotational speed Ne, a first electric motor rotational speed Nmg1, a second electric motor rotational speed Nmg2, a transmission input rotational speed Ni, a transmission output rotational speed No, and an accelerator operation amount θacc. Examples of the various types of signals include an oil temperature THfld, a battery temperature THbat, a battery input/output current Ibat, and a battery voltage Vbat.

The engine rotational speed Ne is the rotational speed of the engine 12. The first electric motor rotational speed Nmg1 is the rotational speed of the first electric motor MG1. The second electric motor rotational speed Nmg2 is the rotational speed of the second electric motor MG2. The transmission input rotational speed Ni is a rotational speed of the transmission input shaft 24i. The transmission output rotational speed No is a rotational speed corresponding to the vehicle speed V and is a rotational speed of the transmission output shaft 24o. The accelerator operation amount θacc is a signal representing an accelerator operation amount of the driver representing a magnitude of the acceleration/deceleration operation of the driver. The oil temperature THfld is the temperature of the oil FLD. The battery temperature THbat is the temperature of the battery 54. The battery input/output current Ibat is a current inputted to the battery 54 and a current outputted from the battery 54. The battery voltage Vbat is the voltage of the battery 54.

The electronic control device 80 calculates the remaining charge amount SOC [%] based on, for example, the battery input/output current Ibat and the battery voltage Vbat. The remaining charge amount SOC is the remaining charge amount of the battery 54 and indicates the state of charge of the battery 54. The electronic control device 80 calculates the inputtable electric power Win [W] and the outputtable electric power Wout [W] of the battery 54 based on, for example, the battery temperature THbat and the remaining charge amount SOC. The inputtable electric power Win is the maximum power that can be input that defines the limit of the inputtable electric power of the battery 54, and indicates the input limit or charge limit of the battery 54. The outputtable electric power Wout is the maximum power that can be output that defines the limit of the output power of the battery 54, and indicates the output limit or discharging limit of the battery 54.

Various command signals and the like are output from the electronic control device 80 to each device and the like provided in the vehicle 10. Each of the devices is, for example, a hydraulic control circuit 38, an engine control device 50, an inverter 52, or the like. Examples of the various command signals include a LU hydraulic control command signal Slu, an engine control command signal Se, a first electric motor control command signal Smg1, and a second electric motor control command signal Smg2.

The electronic control device 80 includes a target drive force calculation unit 82 in order to realize various kinds of control in the vehicle 10. The target drive force calculation unit 82 calculates the target drive force Frtgt of the vehicle 10 by, for example, applying the accelerator operation amount θacc and the vehicle speed V to the target drive force map. The target drive force map is, for example, a relation for determining a target drive force Frtgt which is determined and stored in advance experimentally or by design, that is, predetermined. The target drive force Frtgt is a target value of the drive force Fr in the drive wheels 14.

When the drive force Fr on the acceleration side of the vehicle 10 is a positive value, the drive force Fr on the deceleration side of the vehicle 10 is a negative value. In the present embodiment, the drive force Fr on the deceleration side is referred to as a deceleration force Frr, and the target drive force Frtgt on the deceleration side is referred to as a target deceleration force Frrtgt. The deceleration force Frr is synonymous with the driven force. The side where the deceleration force Frr (< 0) is smaller is the side where the absolute value of the deceleration force Frr is larger. However, for convenience, for example, the fact that the absolute value of the deceleration force Frr is large is simply expressed as a large deceleration force Frr, and the fact that the absolute value of the deceleration force Frr is small is simply expressed as a small deceleration force Frr. The same applies to each of the regenerative braking force Frb and the engine braking force Feb, which will be described later.

When the target drive force Frtgt calculated by the target drive force calculation unit 82 is negative, the electronic control device 80 controls the deceleration force Frr so that the target deceleration force Frrtgt is realized. That is, when the target deceleration force Frrtgt is calculated by the target drive force calculation unit 82, the electronic control device 80 that controls the deceleration force Frr so that the target deceleration force Frrtgt is realized further includes a deceleration control unit 84 for controlling the deceleration force Frr.

The deceleration force Frr is realized by, for example, applying the regenerative braking force Frb by the regenerative operation of the electric motor MG and/or the engine braking force Feb by the fuel cut FC to the drive wheels 14. The regenerative braking force Frb is a braking force caused by a negative motor torque Tmg applied to the drive wheels 14 by executing the regenerative operation of the electric motor MG. The regenerative operation of the electric motor MG is a control in which the electric motor MG is rotationally driven by the driven torque input from the drive wheels 14 to operate as a generator, and the generated electric power is input to the battery 54 via the inverters 52. The regenerative braking force Frb includes a first regenerative braking force Frb1, which is a regenerative braking force generated by regenerative operation of the first electric motor MG1, and a second regenerative braking force Frb2, which is a braking force generated by regenerative operation of the second electric motor MG2. The engine braking force Feb is a braking force caused by a negative engine torque Te corresponding to the engine rotational speed Ne, which is applied to the drive wheels 14 by executing the fuel cut FC. The fuel cut FC is a control for stopping the supply of fuel to the engine 12, and is synonymous with the fuel cut. The negative engine torque Te is a torque caused by a rotational resistance such as a pumping loss or a friction torque caused by the driven rotation of the engine 12.

The deceleration force Frr of the vehicle 10 is preferentially applied by the regenerative braking force Frb from the viewpoint of energy-efficiency improvement, for example. In the regenerative operation of the electric motor MG, the electric power generated by the electric motor MG is inputted to the battery 54. When the generated electric power generated by the regenerative operation of the electric motor MG when the target deceleration force Frrtgt is realized exceeds the inputtable electric power Win of the battery 54, the target deceleration force Frrtgt cannot be realized only by the regenerative braking force Frb. Here, for example, an engine braking force Feb is applied in combination.

The deceleration control unit 84 determines whether or not the target deceleration force Frrtgt can be realized by the regenerative braking force Frb that falls within the inputtable electric power Win. The regenerative braking force Frb that falls within the range of the inputtable electric power Win is synonymous with the regenerative braking force Frb by the regenerative operation of the electric motor MG that generates generated electric power within the range of the inputtable electric power Win. The deceleration control unit 84 determines whether or not the target deceleration force Frrtgt can be realized based on whether or not the traveling power Prr (absolute value) for realizing the target deceleration force Frrtgt is equal to or less than the inputtable electric power Win (absolute value), with the regenerative braking force Frb that falls within the inputtable electric power Win. The deceleration control unit 84 calculates a multiplication value of the target deceleration torque Trrtgt obtained by converting the target deceleration force Frrtgt by the tire radius and the vehicle speed V as the traveling power Prr [W]. The vehicle speed V is synonymous with the speed of the drive wheels 14.

The deceleration control unit 84 outputs the electric motor torque Tmg that applies the regenerative braking force Frb so as to realize the target deceleration force Frrtgt when it is determined that the target deceleration force Frrtgt can be realized with the regenerative braking force Frb that falls within the range of the inputtable electric power Win. At this time, for example, the deceleration control unit 84 releases LU clutch 36 and does not stop supplying fuel to the engine 12. When LU clutch 36 is released, the first regenerative braking force Frb1 cannot be applied. When the first regenerative braking force Frb1 is applied, LU clutch 36 needs to be locked up. In this case, K0 clutch 20 is released. The first regenerative braking force Frb1 is influenced by a control condition of LU clutch 36 and the like. When only the regenerative braking force Frb is applied, it is preferable to use the second regenerative braking force Frb2 that is not affected by the control condition of LU clutch 36 or the like. When it is determined that the target deceleration force Frrtgt can be realized by the regenerative braking force Frb that falls within the range of the inputtable electric power Win, the deceleration control unit 84 performs regenerative operation of the second electric motor MG that applies the second regenerative braking force Frb2 that realizes the target deceleration force Frrtgt.

The deceleration control unit 84 determines that the engine braking force Feb by the fuel cut FC is required when it is determined that the target deceleration force Frrtgt cannot be realized in the regenerative braking force Frb that falls within the range of the inputtable electric power Win. The deceleration control unit 84 performs the fuel cut FC when it is determined that the engine braking force Feb by the fuel cut FC is required, and locks up LU clutch 36. When the engine braking force Feb is applied, K0 clutch 20 is engaged. As described above, in the regenerative braking force Frb, when the target deceleration force Frrtgt cannot be realized within the inputtable electric power Win, the deceleration control unit 84 determines that the engine braking force Feb is required, and brings LU clutch 36 into engagement.

Even when an attempt is made to lock up LU clutch 36, it may not be possible to perform the lock up. For example, when the oil temperature THfld is less than the predetermined low oil temperature THfldlow, the lock-up cannot be performed. The predetermined low-oil-temperature THfldlow is, for example, a lower limit at which controllability of the engagement condition of LU clutch 36 can be secured, which is determined in advance. For example, when the oil temperature THfld is less than the predetermined low oil temperature THfldlow, the deceleration control unit 84 does not lock up LU clutch 36.

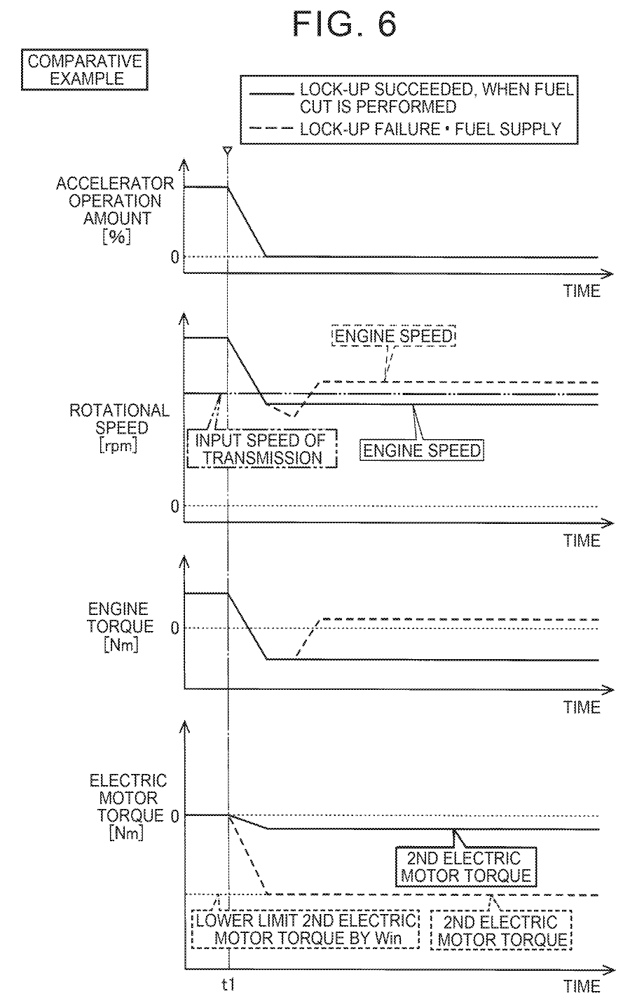

FIG. 6 is a diagram for explaining a comparative example when the lock-up of LU clutch 36 is disabled. In FIG. 6, t1 time point indicates a time point at which the accelerator-off operation is started. When the target deceleration force Frrtgt cannot be realized in the regenerative braking force Frb that falls within the inputtable electric power Win during deceleration running of the accelerator-off, lockup of LU clutch 36 and fuel cut FC of the engine 12 are performed. The solid line represents a case where the lock-up is successful in the slip-state, and the target deceleration force Frrtgt is realized by the engine braking force Feb due to the negative engine rotational speed Ne and the regenerative braking force Frb due to the negative second electric motor torque Tmg2. On the other hand, as in the comparative example shown by the broken line, when the lock-up fails, the engine 12 is supplied with fuel, and the engine braking force Feb cannot be obtained. At this time, only the regenerative braking force Frb due to the negative second electric motor torque Tmg2 is applied while the generated electric power is limited in the inputtable electric power Win. Therefore, the target deceleration force Frrtgt is not realized.

The deceleration control unit 84 determines whether or not lockup can be realized when the lockup of LU clutch 36 and the fuel cut FC of the engine 12 are performed. When it is determined that the lockup can be realized, the deceleration control unit 84 puts LU clutch 36 into engagement and performs the fuel cut FC. In addition, the deceleration control unit 84 performs regenerative operation of the second electric motor MG that applies the second regenerative braking force Frb2 that is insufficient in the engine braking force Feb with respect to the target deceleration force Frrtgt. In the present embodiment, the series of controls when it is determined that the lockup can be realized is referred to as a deceleration control CNrslu when the lockup succeeds.

When the lockup cannot be realized, the engine 12 in which the fuel cut FC is performed is rotationally driven by the power running operation of the first electric motor MG1, and the engine rotational speed Ne is maintained at a predetermined value or more. When the first electric motor MG1 is operated to maintain the engine rotational speed Ne, K0 clutch 20 is engaged. The power generated by the regenerative operation of the second electric motor MG can be increased by the amount of power consumed by the power action operation of the first electric motor MG1. The generated electric power of the second electric motor MG exceeding the inputtable electric power Win can be generated, and the target deceleration force Frrtgt can be realized by the second regenerative braking force Frb2. The engine rotational speed Ne when the first electric motor MG1 is rotationally driven by the power running operation is set to, for example, an engine rotational speed Ne when it is assumed that LU clutch 36 is locked up. In the present embodiment, the engine rotational speed Ne when LU clutch 36 is engaged is referred to as a lock-up engine rotational speed Nelu. When it is determined that the lockup cannot be realized, the deceleration control unit 84 performs the power running operation of the first electric motor MG1 that maintains the engine rotational speed Ne at the lockup time engine rotational speed Nelu in the released condition of LU clutch 36 while performing the fuel cut FC. In addition, the deceleration control unit 84 performs regenerative operation of the second electric motor MG that applies the second regenerative braking force Frb2 that realizes the target deceleration force Frrtgt. In the present embodiment, the series of controls when it is determined that the lockup cannot be realized is referred to as a deceleration control CNrslf when the lockup fails.

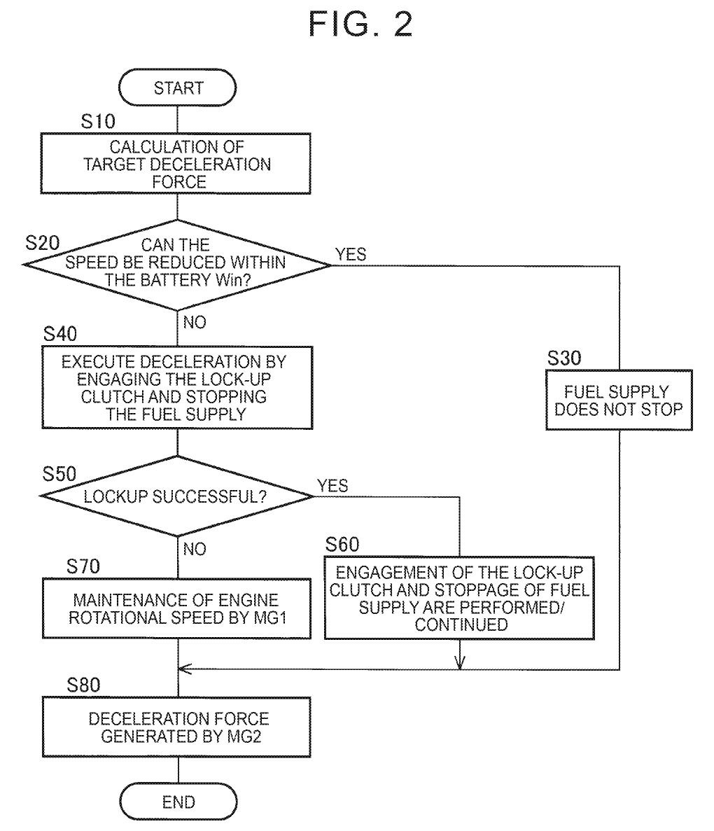

FIG. 2 is a flowchart for explaining a main part of the control operation of the electronic control device 80, and is a flowchart for explaining a control operation for realizing a desired deceleration force Frr, and is repeatedly executed, for example.

In FIG. 2, first, the target deceleration force Frrtgt is calculated in a step (hereinafter, step is omitted) S10 corresponding to the function of the target drive force calculation unit 82. Next, in S20 corresponding to the function of the deceleration control unit 84, it is determined whether or not the target deceleration force Frrtgt can be realized by the regenerative braking force Frb that falls within the inputtable electric power Win. When the determination of S20 is affirmative, for example, LU clutch 36 is released and the fuel-supply to the engine 12 is not stopped in S30 corresponding to the function of the deceleration control unit 84. When the determination of S20 is negative, the deceleration is performed by the lock-up of LU clutch 36 and the fuel cut FC of the engine 12 in S40 corresponding to the function of the deceleration control unit 84. Next, in S50 corresponding to the function of the deceleration control unit 84, it is determined whether or not the lock-up is successful. When the determination of S50 is affirmative, the lockup of LU clutch 36 and the fuel cut FC of the engine 12 are performed or continued in S60 corresponding to the function of the deceleration control unit 84. When the determination of S50 is negative, the engine rotational speed Ne is maintained at, for example, the engine rotational speed Nelu during lock-up by the first electric motor MG1 in the released condition of LU clutch 36 while the fuel cut FC is performed in S70 corresponding to the function of the deceleration control unit 84. After S30 or after S60 or after S70, in a S80 corresponding to the function of the deceleration control unit 84, the deceleration force Frr by the regenerative operation of the second electric motor MG that applies the second regenerative braking force Frb2 is outputted.

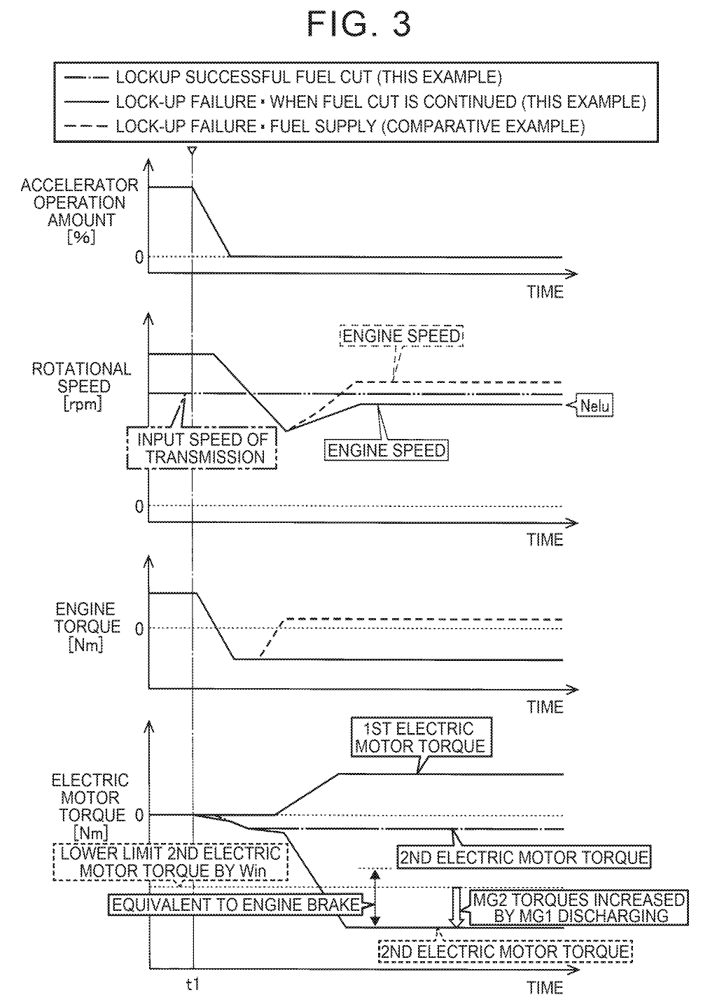

FIG. 3 is a diagram illustrating an example of a time chart when the control operation illustrated in the flowchart of FIG. 2 is executed. In FIG. 3, t1 time point indicates a time point at which the accelerator-off operation is started. When the target deceleration force Frrtgt cannot be realized in the regenerative braking force Frb that falls within the inputtable electric power Win during deceleration running of the accelerator-off, lockup of LU clutch 36 and fuel cut FC of the engine 12 are performed. The present embodiment illustrated by the dashed-dotted line is the case where the lock-up is successful in the slip state, and is the same as the embodiment illustrated by the solid line in FIG. 6. The comparative example shown by the broken line is the case where the lock-up has failed, and is the same as the embodiment shown by the broken line in FIG. 6. On the other hand, as in the present embodiment shown by the solid line, when the lock-up fails, the fuel cut FC of the engine 12 is performed, and the engine rotational speed Ne is maintained at the engine rotational speed Nelu during the lock-up, for example, by the first electric motor MG1. Although the engine braking force Feb is not obtained, it is possible to increase the generated electric power by the regenerative operation of the second electric motor MG by the amount of electric power consumed by the power action operation of the first electric motor MG1. A second regenerative braking force Frb2 corresponding to the engine braking force Feb can be applied. In a portion that is insufficient in the second regenerative braking force Frb2 corresponding to the engine braking force Feb with respect to the target deceleration force Frrtgt, the second regenerative braking force Frb2 by the regenerative operation of the second electric motor MG that generates the generated electric power inputted to the battery 54 is applied. Consequently, discharging by the power action operation of the first electric motor MG1 increases the negative second electric motor torque Tmg2 by the generated electric power exceeding the inputtable electric power Win.

In the regenerative braking force Frb, when the target deceleration force Frrtgt cannot be realized within the inputtable electric power Win, the engine braking force Feb by the lock-up and the fuel cut FC is applied. However, even when the engine braking force Feb is applied, the target deceleration force Frrtgt may not be realized. In this case, LU clutch 36 is released, and the same control as the deceleration control CNrslf is executed when the lock-up fails. However, the engine rotational speed Ne maintained by the power running operation of the first electric motor MG1 is set to a higher engine rotational speed Ne than the lock-up engine rotational speed Nelu.

The deceleration control unit 84 determines whether or not the target deceleration force Frrtgt can be realized by the engagement status of LU clutch 36, the engine braking force Feb due to the fuel cut FC, and the regenerative braking force Frb that falls within the inputtable electric power Win. The deceleration control unit 84 determines whether or not the traveling power Prr (absolute value) for realizing the target deceleration force Frrtgt is equal to or less than the sum of the fuel cut power Pfc (absolute value) consumed in the fuel cut FC and the inputtable electric power Win (absolute value). Based on this determination, the deceleration control unit 84 determines whether or not the target deceleration force Frrtgt can be realized by the engine braking force Feb and the regenerative braking force Frb that falls within the inputtable electric power Win. The deceleration control unit 84 calculates the multiplication of the lockup-time engine rotational speed Nelu and the negative engine torque Te as the fuel cut power Pfc [W]. The negative engine torque Te is determined in advance in the engine rotational speed Nelu at the time of lock-up when the fuel cut FC is performed.

The deceleration control unit 84 performs deceleration control CNrslu when LU clutch 36 is determined to be engaged when it is determined that the target deceleration force Frrtgt can be realized by the engine braking force Feb and the regenerative braking force Frb that is within the inputtable electric power Win.

The deceleration control unit 84 performs deceleration control CNrslf at the time of lock-up failure when it is determined that LU clutch 36 cannot be brought into engagement when it is determined that the target deceleration force Frrtgt can be realized by the engine braking force Feb and the regenerative braking force Frb that is within the inputtable electric power Win. In the lock-up failure deceleration control CNrslf, the deceleration control unit 84 sets the target engine rotational speed Netgt to be maintained by the power running operation of the first electric motor MG1 to the lock-up engine rotational speed Nelu. The target engine rotational speed Netgt is a target of the engine rotational speed Ne.

When it is determined that the target deceleration force Frrtgt cannot be realized with the engine braking force Feb and the regenerative braking force Frb that is within the inputtable electric power Win, the deceleration control unit 84 performs the fuel cut FC of the engine 12 and releases LU clutch 36. In addition, the deceleration control unit 84 performs the power running operation of the first electric motor MG1 that maintains the engine rotational speed Ne at the predetermined engine rotational speed Nef. Further, the deceleration control unit 84 performs regenerative operation of the second electric motor MG2 for generating generated electric power corresponding to the combined electric power of the generated electric power corresponding to the inputtable electric power Win and the electric power consumed by the power action operation of the first electric motor MG1. In the present embodiment, the series of controls when it is determined that the target deceleration force Frrtgt cannot be realized is referred to as a lock-up release deceleration control CNrstc.

In the lock-up release deceleration control CNrstc, the deceleration control unit 84 sets the target engine rotational speed Netgt to be maintained by the power running operation of the first electric motor MG1 to a predetermined engine rotational speed Nef higher than the lock-up engine rotational speed Nelu. The predetermined engine rotational speed Nef is a rotational speed obtained by adding an increase in the engine rotational speed Ne due to the power running operation of the first electric motor MG1 when the increase in the generated electric power generated by the regenerative operation of the second electric motor MG2 is consumed to the engine rotational speed Nelu during lock-up. The increase in the generated electric power generated by the regenerative operation of the second electric motor MG2 is an increase in the generated electric power generated by the regenerative operation of the second electric motor MG2 that imparts a shortage of the second regenerative braking force Frb2 to the target deceleration force Frrtgt. The amount that is insufficient with respect to the target deceleration force Frrtgt is an amount that is insufficient with respect to the engine braking force Feb and the regenerative braking force caused by the regenerative operation of the second electric motor MG2 that generates the generated electric power corresponding to the inputtable electric power Win.

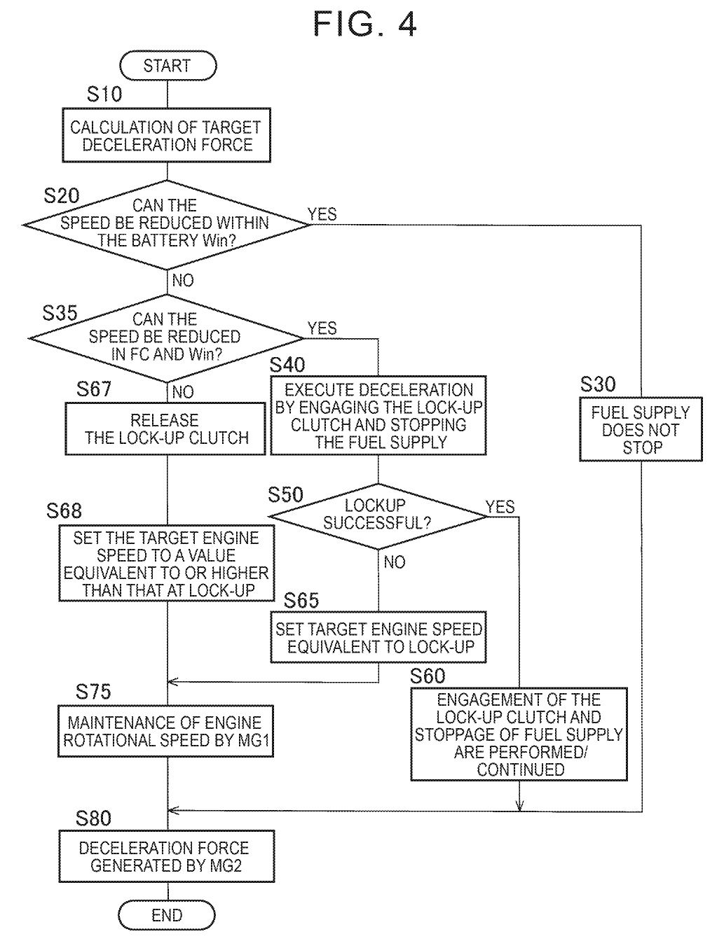

FIG. 4 is a flowchart for explaining a main part of the control operation of the electronic control device 80. FIG. 4 is a flowchart illustrating a control operation for realizing a desired deceleration force Frr even when the engine braking force Feb, the regenerative braking force Frb by the electric motor MG within the inputtable electric power Win, and the deceleration force Frr obtained by the electric motor are smaller than the target deceleration force Frrtgt. This control operation is repeatedly executed, for example.

In FIG. 4, the steps having the same functions as those of the flowchart of FIG. 2 are denoted by the same reference numerals. First, S10 is executed. S20 is then performed. When the determination of S20 is affirmative, S30 is executed. When the determination of S20 is negative, it is determined whether or not the target deceleration force Frrtgt can be realized by the engine braking force Feb and the regenerative braking force Frb that is within the inputtable electric power Win in S35 corresponding to the function of the deceleration control unit 84. When the determination of S35 is affirmative, S40 is executed. S50 is then performed. When the determination of S50 is affirmative, S60 is executed. When the determination of S50 is negative, the target engine rotational speed Netgt at the time of being maintained by the power running operation of the first electric motor MG1 is set to the lock-up engine rotational speed Nelu in S65 corresponding to the function of the deceleration control unit 84. When the determination of S35 is negative, the fuel cut FC of the engine 12 is performed in S67 corresponding to the function of the deceleration control unit 84, and LU clutch 36 is released. Next, in S68, the target engine rotational speed Netgt to be maintained by the power running operation of the first electric motor MG1 is set to a predetermined engine rotational speed Nef higher than the lock-up engine rotational speed Nelu. S68 corresponds to the function of the deceleration control unit 84. Following S65 or following S68, a S75 is performed. In S75, the engine rotational speed Ne is maintained at the target engine rotational speed Netgt by the first electric motor MG1 while the fuel cut FC is performed and LU clutch 36 is released. S75 corresponds to the function of the deceleration control unit 84. Following S30, or following S60, or following S75, S80 is performed.

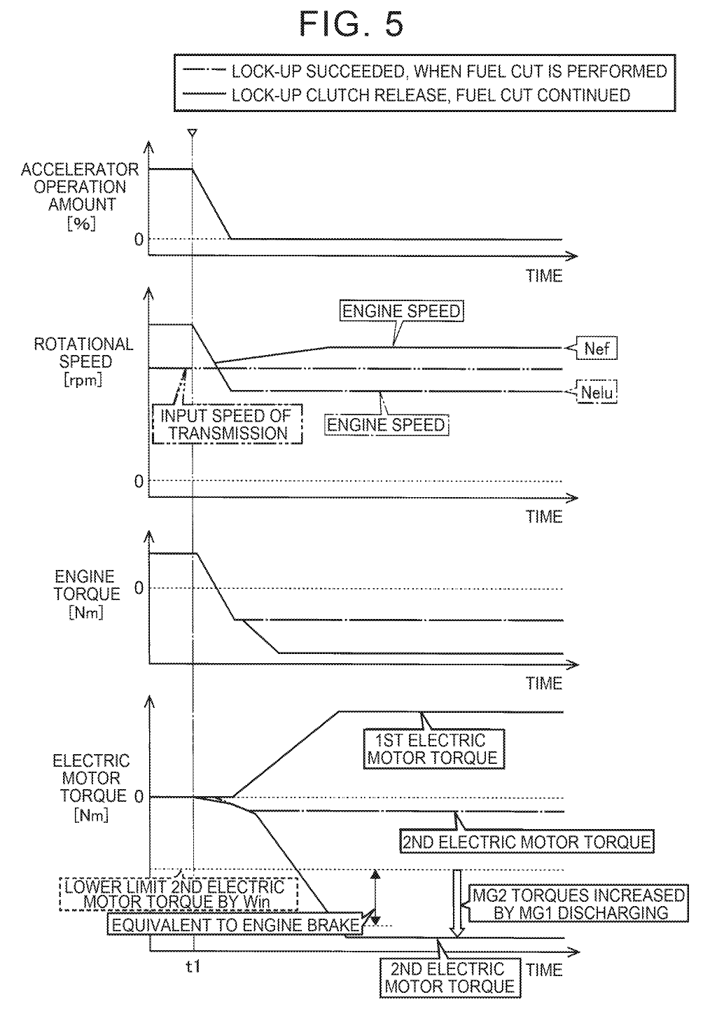

FIG. 5 is a diagram illustrating an example of a time chart when the control operation illustrated in the flowchart of FIG. 4 is executed. In FIG. 5, t1 time point indicates a time point at which the accelerator-off operation is started. When the target deceleration force Frrtgt can be realized by the engine braking force Feb and the regenerative braking force Frb that falls within the inputtable electric power Win during deceleration running of the accelerator-off, lockup and fuel cut FC are performed (see the dashed-dotted line). The present embodiment illustrated by the dashed-dotted line is the case where the lock-up is successful in the slip state, and is the same as the embodiment illustrated by the solid line in FIG. 6. When the target deceleration force Frrtgt cannot be realized by the engine braking force Feb and the regenerative braking force Frb that is within the inputtable electric power Win during deceleration running of the accelerator-off, LU clutch 36 is released and the fuel cut FC is performed (see the solid line). In the present embodiment shown by the solid line, the engine rotational speed Ne is maintained at a predetermined engine rotational speed Nef higher than the engine rotational speed Nelu during lock-up by the first electric motor MG1. Although the engine braking force Feb is not obtained, it is possible to increase the generated electric power by the regenerative operation of the second electric motor MG by the amount of electric power consumed by the power action operation of the first electric motor MG1. That is, since the negative torque due to friction or the like in the engine 12 increases, the first electric motor torque Tmg1 (positive value) for maintaining this also increases, the power consumed by the first electric motor MG1 increases, and the negative torque (power generation) outputted by the second electric motor MG2 also increases. In addition to the second regenerative braking force Frb2 corresponding to the inputtable electric power Win, a second regenerative braking force Frb2 larger than the second regenerative braking force Frb2 corresponding to the engine braking force Feb can be applied. Consequently, by discharging by the power action operation of the first electric motor MG1, the negative second electric motor torque Tmg2 is increased by the amount of the generated electric power exceeding Win of the inputtable electric power, so that the target deceleration force Frrtgt can be realized.

As described above, according to the present embodiment, in the regenerative braking force Frb, when the target deceleration force Frrtgt is not realized within the inputtable electric power Win, it is determined that the engine braking force Feb by the fuel cut FC is required, and lockup is performed. As a result, the deceleration force Frr is obtained by the regenerative braking force Frb and the engine braking force Feb, so that the target deceleration force Frrtgt is easily realized.

Further, according to the present embodiment, when the target deceleration force Frrtgt is not realized in the engine braking force Feb and the regenerative braking force Frb within the inputtable electric power Win, the deceleration control CNrstc is performed at the time of lock-up release. Accordingly, the power consumed in the power running operation of the first electric motor MG1 is increased as compared with the case where the engine rotational speed Ne is maintained at the engine rotational speed Nelu during lock-up. Therefore, the power generated by the regenerative operation of the second electric motor MG2 is increased, and the second regenerative braking force Frb2 is also increased. The regenerative operation of the second electric motor MG2 is performed, in which the engine braking force Feb, the regenerative braking force Frb within the inputtable electric power Win, and the deceleration force Frr greater than the deceleration force Frr obtained can be obtained. Therefore, the desired deceleration force Frr can be realized even when the engine braking force Feb, the regenerative braking force Frb within the inputtable electric power Win, and the deceleration force Frr obtained by the engine braking force Frrtgt are smaller than the target deceleration force.

Further, according to the present embodiment, in the lock-up release time deceleration control CNrstc, the target engine rotational speed Netgt at the time of being maintained by the power running operation of the first electric motor MG1 is set to a predetermined engine rotational speed Nef higher than the lock-up time engine rotational speed Nelu. As a result, the regenerative operation of the second electric motor MG2 is appropriately performed, in which the engine braking force Feb, the regenerative braking force Frb within the inputtable electric power Win, and the deceleration force Frr larger than the deceleration force Frr obtained can be obtained.

Further, according to the present embodiment, when the target deceleration force Frrtgt is realized by the engine braking force Feb and the regenerative braking force Frb that is within the inputtable electric power Win, when the target deceleration force is locked up, the deceleration control CNrslu is performed when the lockup succeeds. Thus, only the regenerative braking force Frb appropriately realizes the target deceleration force Frrtgt when the target deceleration force Frrtgt cannot be realized within the inputtable electric power Win.

Further, according to the present embodiment, when the target deceleration force Frrtgt is realized by the engine braking force Feb and the regenerative braking force Frb that is within the inputtable electric power Win, when the target deceleration force is not locked up, the deceleration control CNrslf is performed when the lockup fails. Thus, only the regenerative braking force Frb cannot realize the target deceleration force Frrtgt within the inputtable electric power Win, and when the lockup is not performed, the target deceleration force Frrtgt is appropriately realized.

Further, according to the present embodiment, when the target deceleration force Frrtgt is realized by the regenerative braking force Frb that is within the inputtable electric power Win, the regenerative operation of the second electric motor MG that applies the second regenerative braking force Frb2 that realizes the target deceleration force Frrtgt is performed. Accordingly, the target deceleration force Frrtgt is realized by the regenerative operation of the second electric motor MG without depending on the control condition of LU clutch 36 and the like, thereby improving the energy-efficiency.

Although the embodiments of the disclosure have been described in detail with reference to the drawings, the disclosure is also applicable to other modes.

For example, in the above-described embodiment, the automatic transmission 24 may be, for example, a known belt-type continuously variable transmission. Alternatively, the vehicle may be an all-wheel drive vehicle in which all wheels are drive wheels. In this case, for example, the front wheels may be driven by the power source SP (the engine 12, the first electric motor MG1), and the rear wheels may be driven by the second electric motor MG2. In short, the present disclosure can be applied to vehicles including a power source SP, a second electric motor MG2, a torque converter 22, a lock-up clutch 36, and a battery 54. As the fluid transmission device, another fluid transmission device such as a fluid coupling may be used instead of the torque converter 22.

The above description is merely an example, and the disclosure can be implemented in various modified and improved modes based on the knowledge of those skilled in the art.

What is claimed is:

1. A control device for a vehicle including a power source, a fluid transmission device, a direct coupling clutch, a second electric motor, and a power storage device, the power source including an engine and a first electric motor, the fluid transmission device being provided in a power transmission path between the power source and a drive wheel, the direct coupling clutch coupling an input member and an output member of the fluid transmission device, the second electric motor being coupled to the drive wheel not via the fluid transmission device so as to be able to transmit power, and the power storage device exchanging electric power with an electric motor including the first electric motor and the second electric motor, wherein:
the control device includes a deceleration control unit, the deceleration control unit determining that an engine braking force due to a fuel cut in which fuel supply to the engine is stopped is required and bringing the direct coupling clutch into an engaged state, including a slip state and a completely engaged state, when a target deceleration force is not achieved within a range of electric power inputtable to the power storage device with a regenerative braking force due to regenerative operation of the electric motor in which electric power generated by the electric motor is input to the power storage device; and
when the target deceleration force is not achieved with the engine braking force due to the fuel cut and the regenerative braking force due to the regenerative operation of the electric motor in which the electric power is generated within the range of the inputtable electric power and with the direct coupling clutch in the engaged state, the deceleration control unit performs the fuel cut, the direct coupling clutch is brought into a disengaged state, performs power running operation of the first electric motor in which a rotational speed of the engine is maintained at a predetermined engine rotational speed that is higher than the rotational speed of the engine with the direct coupling clutch in the engaged state, and performs regenerative operation of the second electric motor in which the second electric motor is caused to generate electric power corresponding to electric power obtained by adding the generated electric power corresponding to the inputtable electric power and electric power consumed by the power running operation of the first electric motor.

2. The control device according to claim 1, wherein the predetermined engine rotational speed is a rotational speed obtained by adding, to the rotational speed of the engine with the direct coupling clutch in the engaged state, an amount of increase in the rotational speed of the engine due to the power running operation of the first electric motor performed to consume an amount of increase in the electric power generated by the regenerative operation of the second electric motor performed to apply a regenerative braking force for an amount of shortage of the engine braking force and the regenerative braking force due to the regenerative operation of the second electric motor for generating the electric power corresponding to the inputtable electric power for the target deceleration force.

3. The control device according to claim 1, wherein, when the target deceleration force is achieved with the engine braking force and the regenerative braking force due to the regenerative operation of the electric motor for generating the electric power within the range of the inputtable electric power, and when it is possible to bring the direct coupling clutch into the engaged state, the deceleration control unit brings the direct coupling clutch into the engaged state, performs the fuel cut, and performs the regenerative operation of the second electric motor to apply a regenerative braking force for an amount of shortage of the engine braking force for the target deceleration force.

4. The control device according to claim 1, wherein, when the target deceleration force is achieved with the engine braking force and the regenerative braking force due to the regenerative operation of the electric motor for generating the electric power within the range of the inputtable electric power, and when it is not possible to bring the direct coupling clutch into the engaged state, the deceleration control unit performs the fuel cut, performs the power running operation of the first electric motor in which the rotational speed of the engine with the direct coupling clutch in the disengaged state is maintained at the rotational speed of the engine with the direct coupling clutch in the engaged state, and performs the regenerative operation of the second electric motor to apply a regenerative braking force for achieving the target deceleration force.

5. The control device according to claim 1, wherein, when the target deceleration force is achieved with the regenerative braking force due to the regenerative operation of the electric motor in which the electric power is generated within the range of the inputtable electric power, the deceleration control unit performs the regenerative operation of the second electric motor to apply a regenerative braking force for achieving the target deceleration force.
